(19) United States
(12) Patent Application Publication
(10) Pub. No.: US 2017/0139774 A1
(43) Pub. Date: May 18, 2017

(54) CORRECTION APPARATUS AND CORRECTION METHOD

(71) Applicant: Kabushiki Kaisha Toshiba, Tokyo (JP)

(72) Inventors: Yuichi MIYAMURA, Yokohama Kanagawa (JP); Masayuki OKAMOTO, Kawasaki Kanagawa (JP)

(21) Appl. No.: 15/260,759

(22) Filed: Sep. 9, 2016

(30) Foreign Application Priority Data
Nov. 17, 2015 (JP) 2015-225024

(51) Int. Cl. G06F 11/10; G06F 7/20

(52) U.S. Cl. CPC G06F 11/1076; G06F 7/20

(57) ABSTRACT

According to an embodiment, a correction apparatus includes an acquisition unit and a detector. The acquisition unit acquires a plurality of entries each including a plurality of elements. The detector extracts, from the plurality of entries, a plurality of second entries each having a second element which is common to a second element of a first entry, the first entry being an entry selected from the plurality of entries, the second element of the first entry being an entry other than a first element of the first entry, the first element of the first entry being an element selected from elements included in the first entry, and detects whether or not the first element of the first entry is a correction target based on first elements of the second entries.

### CROSS-REFERENCE TO RELATED APPLICATIONS

This application is based upon and claims the benefit of priority from Japanese Patent Application No. 2015-225024, filed Nov. 17, 2015, the entire contents of which are incorporated herein by reference.

### FIELD

Embodiments described herein relate generally to a correction apparatus and a correction method.

### BACKGROUND

As opportunities for utilizing big data enhance, the need for extracting from data information desired by a user have been increasing. In a case of extracting information from a large amount of data, such as big data, manually extracting information one by one is too costly. Therefore, in general, information is automatically extracted by a machine-learning technique, or the like. However, when automatically extracting information, if the original data of a source includes an error, the error may not be noticed and the extracted information may also remain erroneous.

To correct the error as described above, there is a known method in which information is extracted from a document, and any inconsistency between the extracted information and database information prepared in advance is detected, thereby detecting and correcting the error.

In the method described above, however, since data inconsistencies are detected based on the database prepared in advance, it is impossible to detect whether or not information that is not present in the database is erroneous.

### BRIEF DESCRIPTION OF THE DRAWINGS

FIG. 1 is a block diagram showing a correction apparatus according to a first embodiment.

FIG. 2 is a diagram showing an example of a document as an extraction source.

FIG. 3 is a diagram showing an example of a correspondence information table.

FIG. 4 is a flow chart showing correction target detection processing of a detector according to the first embodiment.

FIG. 5 is a block diagram showing a correction apparatus according to a modification of the first embodiment.

FIG. 6 is a diagram showing an example of correction candidates.

FIG. 7 is a flow chart showing correction target detection processing of a detector according to the modification of the first embodiment.

FIG. 8 is a block diagram showing a correction apparatus according to a second embodiment.

FIG. 9 is a diagram showing an example of correspondence information including position information in a document.

FIG. 10 is a block diagram showing a correction apparatus according to a third embodiment.

FIG. 11 is a flow chart showing warning processing of a warning output unit according to the third embodiment.

FIG. 12 is a diagram showing an example of a warning output from the warning output unit according to the third embodiment.

FIG. 13 is a block diagram showing a correction apparatus according to a fourth embodiment.

FIG. 14 is a flow chart showing warning processing of a warning output unit according to the fourth embodiment.

FIG. 15 is a diagram showing an example of a warning output from the warning output unit according to the fourth embodiment.

FIG. 16 is a flow chart showing an operation of a correction apparatus according to a fifth embodiment.

FIG. 17 is a diagram showing an example of a warning output from the warning output unit according to the fifth embodiment.

### DETAILED DESCRIPTION

According to an embodiment, a correction apparatus includes an acquisition unit and a detector. The acquisition unit acquires a plurality of entries each including a plurality of elements. The detector extracts, from the plurality of entries, a plurality of second entries each having a second element which is common to a second element of a first entry, the first entry being an entry selected from the plurality of entries, the second element of the first entry being an entry other than a first element of the first entry, the first element of the first entry being an element selected from elements included in the first entry, and detects whether or not the first element of the first entry is a correction target based on first elements of the second entries.

In the following, a correction apparatus and method according to the embodiments will be described in detail with reference to the drawings. In the following embodiments, elements with the same reference symbols are considered as performing the same operation, and redundant explanations thereof will be omitted as appropriate.

### First Embodiment

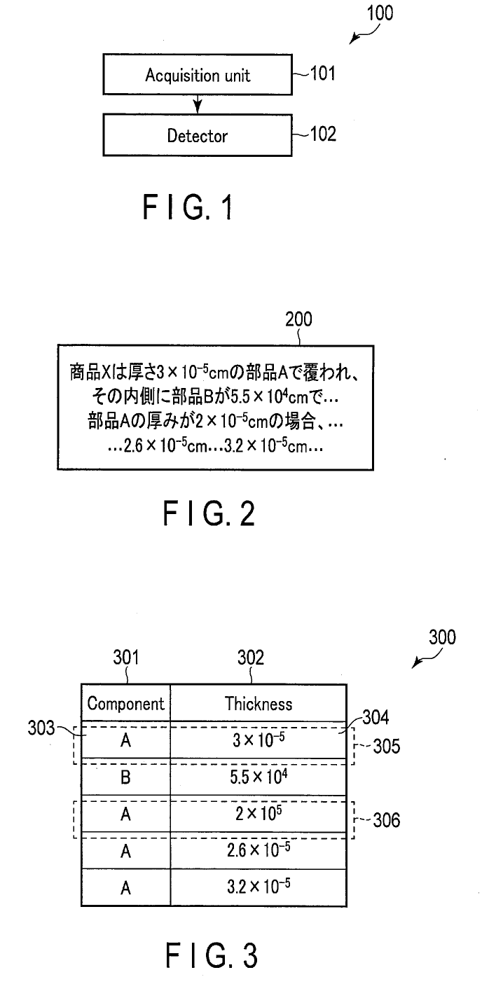

A correction apparatus according to the first embodiment is explained with reference to the block diagram of FIG. 1.

A correction apparatus 100 of the first embodiment includes an acquisition unit 101 and a detector 102.

The acquisition unit 101 externally acquires correspondence information. The correspondence information is information concerning a plurality of terms (also referred to as items) extracted from a document (text data) and a character string corresponding to an item or a numerical value corresponding to the item (also referred to as an element). The correspondence information includes entries each includes a plurality of elements associated with each other in accordance with a relationship between items. In this embodiment, it is assumed that the acquisition unit 101 acquires correspondence information in the form of a table. Details of the correspondence information will be described later with reference to FIG. 2.

The detector 102 receives correspondence information from the acquisition unit 101. The detector 102 extracts, from a plurality of entries included in the correspondence information, a plurality of entries (referred to as second entries) each having a second element that is identical to at least one element (also referred to as a second element) other than an element that is a target of processing (also referred to as a first element) included in a first entry. The detector 102 detects whether or not the first element included in the first entry is a correction target that requires correction, based on the first elements included in the second entries.

In this embodiment, it is assumed that whether or not an element is a correction target is determined as follows: variability in set of the first element of the first entry and the first elements of the second entries is calculated, and if the variability is equal to or greater than a threshold value, the first element of the first entry is determined to be a correction target. The determination of a correction target is not limited to the above. A value of the first element of the first entry (for example, a power exponent in a numerical value) may be simply compared with a value of the first element of each of the second entries, and if the values are not identical, the first element of the first entry may be determined as a correction target.

Next, an example of a document (text data) as a source of correspondence information acquired by the acquisition unit 101 will be explained with reference to FIG. 2.

In this embodiment, a document is assumed to be a catalog of merchandise or a specification document. Terms appearing in the document are extracted as items, and values corresponding to the items are extracted as elements.

To extract items and elements, general techniques such as a combination of OCR (optical character reader) processing and named entity extraction may be used.

A document 200 shown in FIG. 2 reads “ [symbol] X [symbol] 3×10⁻⁵ cm [symbol] A [symbol] , [symbol] B [symbol] 5.5×10⁴ cm [symbol] . . . [symbol] A [symbol] 2×10⁻⁵ cm [symbol] , . . . 2.6×10⁻⁵ cm . . . 3.2×10⁻⁵ cm”. This means that “a product X is covered with a component A of a thickness of 3×10⁻⁵ cm, and a component B inside is 5.5×10⁴ cm, . . . if the component A has a thickness of 2×10⁻⁵ cm, . . . 2.6×10⁻⁵ cm . . . 3.2×10⁻⁵ cm . . . ”. Regarding the document 200, the term “ [symbol] ” (“thickness”) is extracted as an item from the phrase “ [symbol] 3×10⁻⁵ cm [symbol] A” (“a component A of a thickness of 3×10⁻⁵ cm”), and a numerical value “3×10⁻⁵” is extracted as an element corresponding to the item “ [symbol] ” (“thickness”). Similarly, the term “ [symbol] ” (“component”) is extracted as an item, and a character string “A” corresponding to the item “ [symbol] ” (“component”) is extracted as an element. Even if there is a description variation, such as “ [symbol] ” and “ [symbol] ”, whether the two terms are the same or not is determined by using a machine learning technique such as a support vector machine. Thus, a plurality of terms having a description variation can be recognized as one term.

Furthermore, the relationship between items is obtained by using a general technique, such as a morphological analysis and dependency parsing. In the example of FIG. 2, the phrase “ [symbol] X [symbol] 3×10⁻⁵ cm [symbol] A [symbol] [symbol] ” (“a product X is covered with a component A of a thickness of 3×10⁻⁵ cm”) is analyzed by a morphological analysis and dependency parsing. As a result, it is determined that “ [symbol] A” (“component A”) corresponds to “ [symbol] [symbol] 3×10⁻⁵ cm” (“a thickness of 3×10⁻⁵ cm”). A combination of the element “3×10⁻⁵ cm” and the element “A” associated in accordance with the relationship between the items is called an entry.

An example of a table of correspondence information extracted from the document 200 shown in FIG. 2 will be explained with reference to FIG. 3.

A correspondence information table 300 shown in FIG. 3 contains different items of “ [symbol] ” (“component”) 301 and “ [symbol] [symbol] ” (“thickness”) 302. Each of the items is stored in the head portion of a corresponding column. A row of elements corresponding to the respective items is stored as an entry 305. Specifically, the element 303 “A” corresponding to “ [symbol] ” (“component”) 301 and the element 304 “3×10⁻⁵ cm” corresponding to “ [symbol] ” (“thickness”) 302 are associated with each other and stored as the entry 305.

Comparing FIG. 3 with FIG. 2, the numerical value “2×10⁻⁵” in the document 200 is represented as “2×10⁵” in the entry 306. Such a discrepancy may occur, for example, in a case where OCR processing is included in the course of extraction processing. In OCR processing, a character smaller than a normal character size, such as a superscript or a subscript, is likely to be omitted. Besides the OCR processing, a typographical error in the original document may be a cause of such a discrepancy.

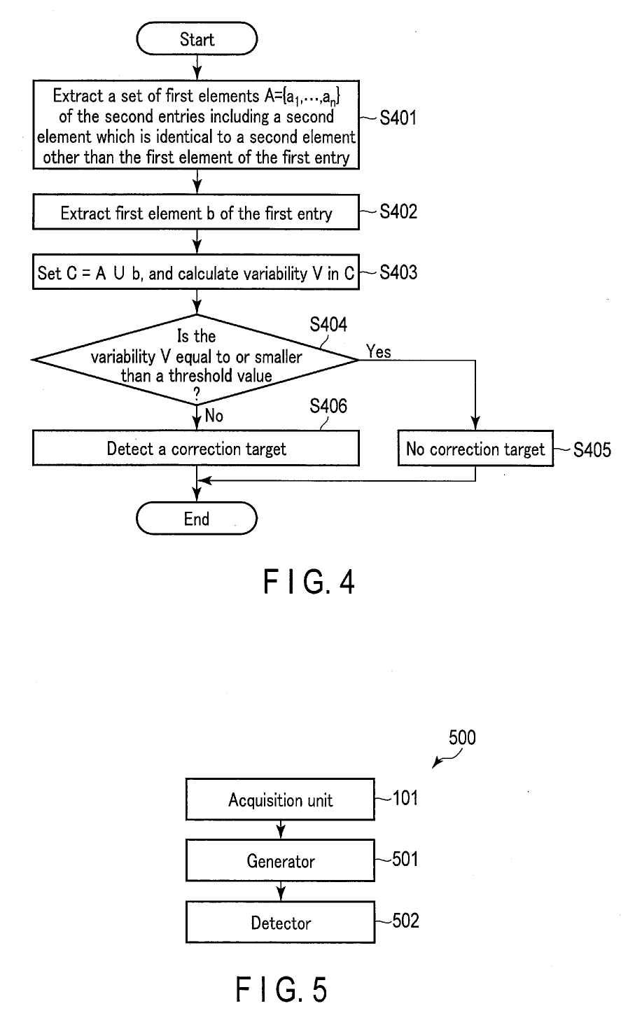

Next, a correction target detecting process in the detector 102 will be described with reference to the flow chart of FIG. 4.

In step S401, the detector 102 extracts, from a plurality of entries, a set of first elements (A={a₁, . . . , aₙ}) of the second entries including a second element which is identical to at least one second element other than the first element of the first entry as a target of processing. The embodiment is described as an example using “identical” as a condition, but is not limited to this example and may include “similar” as a condition. In other words, the condition may be “common” including “identical” and “similar”.

In step S402, the detector 102 extracts a first element b from the first entry.

In step S403, the detector 102 sets a set C=A∪b, and calculates variability V in the set C.

In step S404, the detector 102 determines whether the variability V is equal to or smaller than a threshold value. If the variability V is equal to or smaller than the threshold value, the process proceeds to step S405. If the variability V is greater than the threshold value, the process proceeds to step S406. The threshold value may be a preset value, or may be a value obtained by multiplying an average of the values of the set A by a constant value.

In step S405, the detector 102 determines that there is no correction target.

In step S406, the detector 102 detects that the first element is a correction target, because the variability V greater than the threshold value represents that there is a possibility of a value being associated that has a correspondence relationship different from that of another entry. The operation of the detector 102 is completed by the above process.

The first element may be selected by, for example, determining in advance an item (a column of a table) as a correction target and determining that elements corresponding to the item may be sequentially used as a first element. Alternatively, elements included in the correspondence information may be sequentially determined as a first element. Elements having numerical values of the elements included in the correspondence information may be sequentially determined as a first element.

Furthermore, various methods are considered for selection of an element of an item (an element to be a second element) that should be referred to when extracting the set A of the first elements of the second entries in step S401. For example, in the case of a table form, an item to be referred to may be determined in advance. In the first embodiment, the first elements of the second entries that have elements (second elements) identical to the element (second element) of the first entry in the item “ [symbol] ” (“component”) can be obtained as the set A by determining in advance that a column to be referred to is “ [symbol] ” (“component”).

Furthermore, columns other than the item corresponding to the first element may be sequentially selected one by one or a plurality of columns may be simultaneously selected.

For example, it is assumed that the items included in correspondence information have a three-column structure having “component”, “thickness” and “material”, and the item corresponding to the first element is “thickness”. In this case, a set of first elements of entries having the same second elements of the item “component” and a set of first elements of entries having the same second elements of the item “material” are obtained, and a sum of the sets may be defined as the set A. If a plurality of columns are selected in this case, a set of first elements of entries in which the second elements “component” and “material” are the same may be obtained as the set A.

As a method for calculating the variability, if elements are numerical values, a variance in the sense of mathematics may be calculated. On the other hand, if the elements are not numerical values but character strings or the like, a method of defining the number of different elements in the group as variability may be used. For example, if a set consists of four elements of “AB”, “AC”, “AB”, and “AD”, there are three different elements “AB”, “AC” and “AD”. In this case, the variability, that is, the number of different elements, is three. Therefore, the detector 102 may determine that the smaller the number of differences, the smaller the variability.

### [Modification of First Embodiment]

As a modification, a correction candidate for the first element may be generated, and processing of detecting a correction target may be performed by using the correction candidate.

The correction apparatus according to the modification of the first embodiment is explained with reference to the block diagram of FIG. 5.

A correction apparatus 500 according to the modification of the first embodiment includes an acquisition unit 101, a generator 501, and a detector 502.

The operations of the acquisition unit 101 are the same as those in the first embodiment, and descriptions thereof will be omitted.

The generator 501 acquires correspondence information from the acquisition unit 101, and extracts a first element included in a first entry from the correspondence information. The generator 501 generates a plurality of correction candidates from the first element included in the first entry in accordance with a generation rule.

The detector 502 acquires correspondence information, the first element, and the plurality of correction candidates from the generator 501. The detector 502 extracts, from a plurality of entries included in the correspondence information, a plurality of second entries each having a second element that is identical to at least one second element included in the first entry. The detector 502 calculates variability in a set of the plurality of correction candidates and the first elements included in the plurality of second entries. If a correction candidate (a first correction candidate) which provides the smallest variability is different from a first element included in the first entry, the detector 502 detects the first element included in the first entry as a correction target.

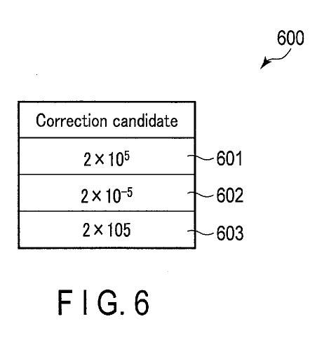

Next, an example of correction candidates generated by the generator 501 will be described with reference to FIG. 6.

A table 600 shown in FIG. 6 indicates correction candidates generated from the first element in accordance with generation rules prepared in advance. The following describes an example of processing, in which the element “2×10⁵” of the entry 306 of the thickness 302 of the item shown in FIG. 3.

The generation rule for generating a plurality of correction candidates may be, for example, as follows:

Generation rule 1 “Use the element without any change as a correction candidate”;

Generation rule 2 “Add ‘-’ to the superscript of the element”; and

Generation rule 3 “Change the superscript of the element to an ordinary character”. The generator 501 generates correction candidates in accordance with the generation rules.

Specifically, a correction candidate 601 “2×10⁵” is generated in accordance with the generation rule 1, a correction candidate 602 “2×10⁻⁵” is generated in accordance with the generation rule 2, and a correction candidate 603 “2×105” is generated in accordance with the generation rule 3.

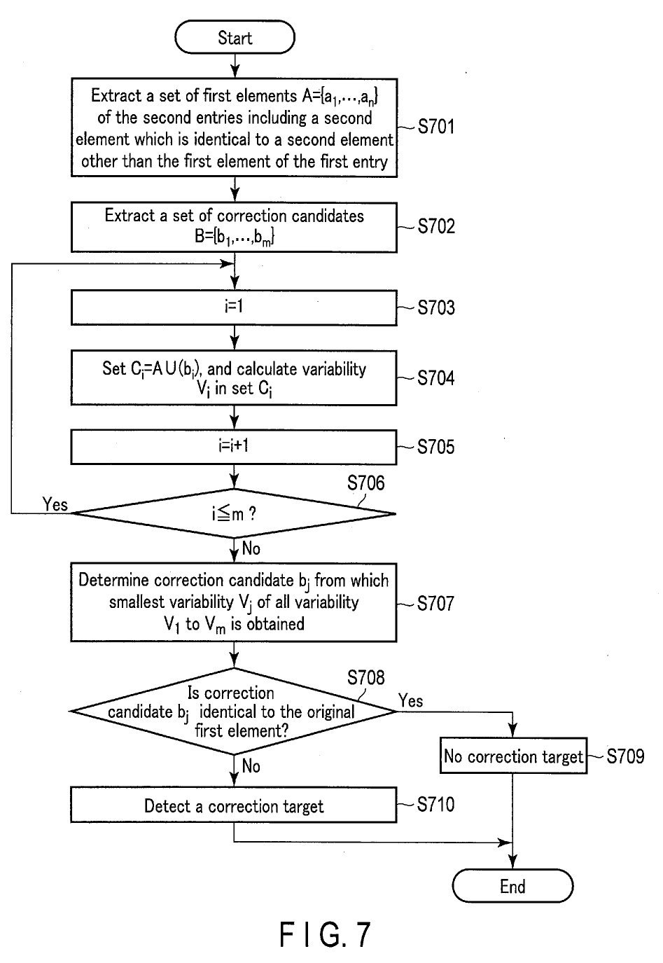

Next, correction candidate detection processing of the detector 502 will be described with reference to the flowchart of FIG. 7.

In step S701, the detector 502 extracts, from a plurality of entries, a set of first elements A={a₁, . . . , aₙ}) of the second entries including a second element which is identical to at least one second element other than the first element of the first entry as a target of processing.

In step S702, the detector 502 extracts a set B of correction candidates b₁, . . . , bₘ, where m is an integer equal to or greater than 2.

In step S703, the detector 502 sets i to 1.

In step S704, the detector 502 sets a set C₁=A∪(b₁), and calculates, variability V in the set C₁.

In step S705, the detector 502 increments i by 1.

In step S706, the detector 502 determines whether i is equal to or smaller than m. If i is equal to or smaller than m, the process returns to step S703, and the same processing is repeated. If i is greater than m, the process proceeds to step S707.

In step S707, the detector 502 determines a correction candidate bⱼ, from which the smallest variability Vⱼ of all variability V₁ to Vₘ is obtained, where j falls within a range 1≦j≦m.

In step S708, the detector 502 determines whether the correction candidate bⱼ is identical to the original extraction result, i.e., the original first element of the first entry. If the correction candidate bⱼ is identical to the original first element of the first entry, the process proceeds to step S709. If the correction candidate bⱼ is not identical to the original first element of the first entry, the process proceeds to step S710.

In step S709, the detector 502 determines that there is no correction target, since the correction candidate bⱼ is identical to the original first element, that is, no correction is necessary.

In step S710, the detector 502 detects the correction candidate bⱼ as a correction target. The operation of the detector 502 is completed by the above process.

Specifically, on the assumption that the entry 306 of FIG. 3 is a first entry, detection processing of detecting whether or not the first element “2×10⁵” of the first entry is a correction target will be explained with reference to FIG. 3 and FIG. 6.

The detector 502 extracts, from the entries in the table shown in FIG. 3, second entries having second elements that are identical to the element (second element) of the item “component 301”, which is an element other than the first element of the item “thickness 302” in the entry 306, and output a set A of first elements of the extracted second entries. Here, the first elements “3×10⁻⁵”, “2.6×10⁻⁵”, and “3.2×10⁻⁵” of the three entries other than the entry 306 and having the second element “A” are extracted as a set A of the first elements of the second entries.

Next, the detector 502 generates three correction candidates shown in FIG. 6: the correction candidate 601 b₁ “2×10⁵” based on the generation rule 1, the correction candidate 602 b₂ “2×10⁻⁵” based on the generation rule 2, and the correction candidate 603 b₃ “2×105” based on the generation rule 3.

Thereafter, the detector 502 calculates variability V₁ of the set C₁={3×10⁻⁵, 2×10⁵, 2.6×10⁻⁵, 3.2×10⁻⁵} (variance in the sense of mathematics). Similarly, the detector 502 calculates variability V₂ of the set C₂={3×10⁻⁵, 2×10⁻⁵, 2.6×10⁻⁵, 3.2×10⁻⁵} and variability V₃ of the set C₃={3×10⁻⁵, 2×105, 2.6×10⁻⁵, 3.2×10⁻⁵}.

The smallest variability is the variability V₂ of a set including the correction candidate 602, in which the elements have the same exponent value of −5. Accordingly, the detector 502 detects the first element “2×10⁵” as a correction target, since the correction candidate 602 “2×10⁻⁵” is different from the original first element “2×10⁵”.

According to the first embodiment described above, it is possible to detect a portion to be corrected included in an information extraction source document, or in information extracted from the information extraction source by taking the variability relating to extracted elements into consideration without preparing a database in advance. Therefore, the versatility of correction can be enhanced.

### Second Embodiment

The second embodiment differs from the embodiment described above in that a correction target is corrected by using a correction candidate.

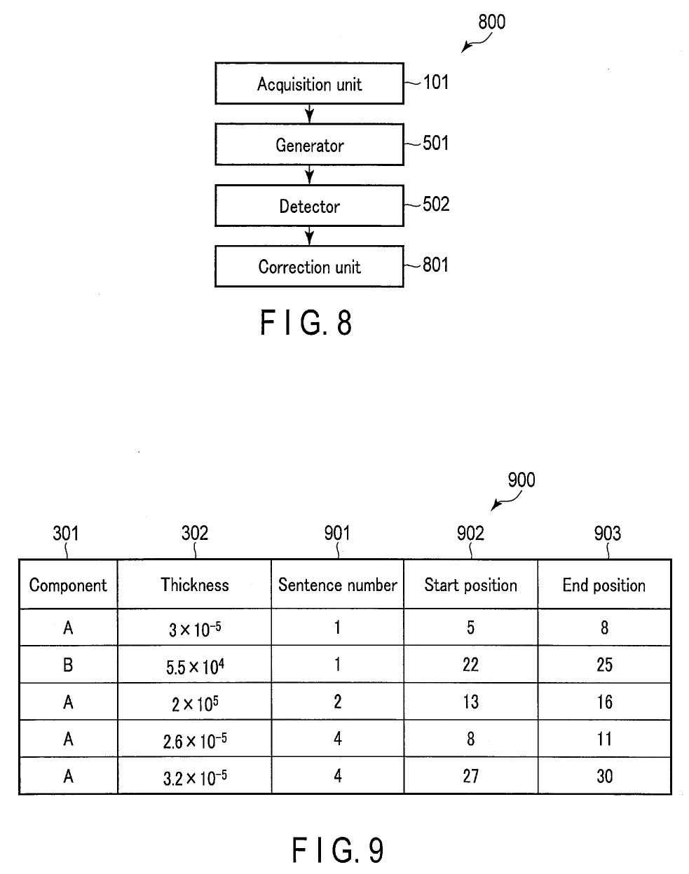

The correction apparatus according to the second embodiment is explained with reference to the block diagram of FIG. 8.

A correction apparatus 800 shown in FIG. 8 includes an acquisition unit 101, a generator 501, a detector 502, and a correction unit 801.

The acquisition unit 101, the generator 501, and the detector 502 perform the same operations as those in the first embodiment, and the explanations thereof will be omitted.

The correction unit 801 receives a correction candidate that makes the variability smallest from the detector 502, and corrects a first element of the first entry to the correction candidate that makes the variability smallest.

If the acquisition unit 101 is able to also receive an original document, both a correction target in correspondence information, and a portion in the original document that corresponds to the correction target may be corrected.

To correct the original document, it is necessary to obtain position information indicating from which part of the original document a term to be a correction target is extracted. An example of correspondence information including position information of the original document will be described with reference to FIG. 9.

A correspondence information table 900 shown in FIG. 9 stores a component 301, a thickness 302, a sentence number 901, a start position 902, and an end position 903 in association with one another.

The sentence number 901 is an identification number that identifies a sentence in the original document. The start position 902 is a position of a character at the head of the sentence of the first element. The end position 903 is a position of a character at the end of the sentence of the first element. In this embodiment, the value of each of the start position 902 and the end position 903 is the number of characters from the head of the sentence indicated by the sentence number 901. However, the value is not limited thereto, but may be any information that can specify the position of the first element.

Although FIG. 9 shows an example of the table storing the sentence number 901, the start position 902, and the end position 903 of the element corresponding to the item “thickness 302”, the table may also store a sentence number 901, a start position 902, and an end position 903 of another item.

According to the second embodiment described above, the versatility of correction can be enhanced by correcting a correction target by using correction candidates.

### Third Embodiment

The third embodiment differs from the embodiments described above in that a warning is output to a user if an error is detected.

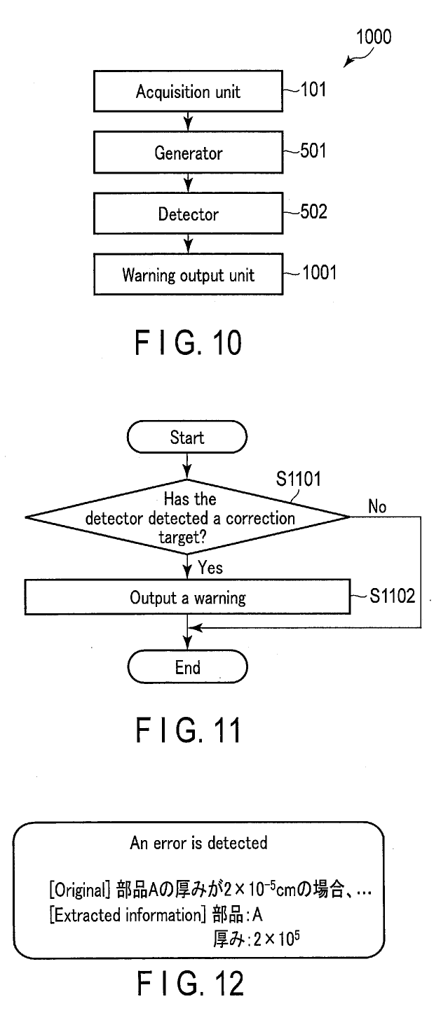

The correction apparatus according to the third embodiment is explained with reference to the block diagram of FIG. 10.

A correction apparatus 1000 shown in FIG. 9 includes an acquisition unit 101, a generator 501, a detector 502, and a warning output unit 1001. The warning output unit 1001 is added to the correction apparatus 500 according to the modification of the first embodiment; however, the warning output unit 1001 may be added to the correction apparatus 100 according to the first embodiment.

The acquisition unit 101, the generator 501, and the detector 502 perform the same operations as those in the first embodiment, and the explanations thereof will be omitted.

The warning output unit 1001 externally outputs a warning when receiving a correction target from the detector 502.

A warning process of the warning output unit 1001 according to the third embodiment will be explained with reference to the flowchart of FIG. 11.

In step S1101, the warning output unit 1001 determines whether the detector 502 has detected a correction target. The warning output unit 1001 can determine that the correction target is detected if it receives the correction target from the detector 502. In this case, the process proceeds to step S1102. If the detector 502 does not detect a correction target, the processing is ended.

In step S1102, the warning output unit 1001 outputs a warning. The warning may be output by a general notification method, such as displaying of an image on a display, notification by a sound via a speaker, etc.

An example of an output of a warning by the warning output unit 1001 according to the third embodiment will be explained with reference to FIG. 12.

In the example of the output of the warning shown in FIG. 12, a message “an error is detected” is displayed along with an original text (original document) and information (correspondence information) extracted from the original document. Looking at the warning shown in FIG. 12, the user can immediately understand that the original document “ [symbol] 2×10⁻⁵ cm” (“a thickness of 2×10⁻⁵ cm”) and “2×10⁵” in the correspondence information are inconsistent.

According to the third embodiment described above, because of the output of the warning, the user can easily determine whether the result detected as a correction target is correct or not. Therefore, the versatility of correction can be enhanced.

### Fourth Embodiment

The fourth embodiment is different from the second embodiment in that a warning output unit is added to the correction apparatus 800 of the second embodiment, so that a warning is output in a case of correcting a correction target.

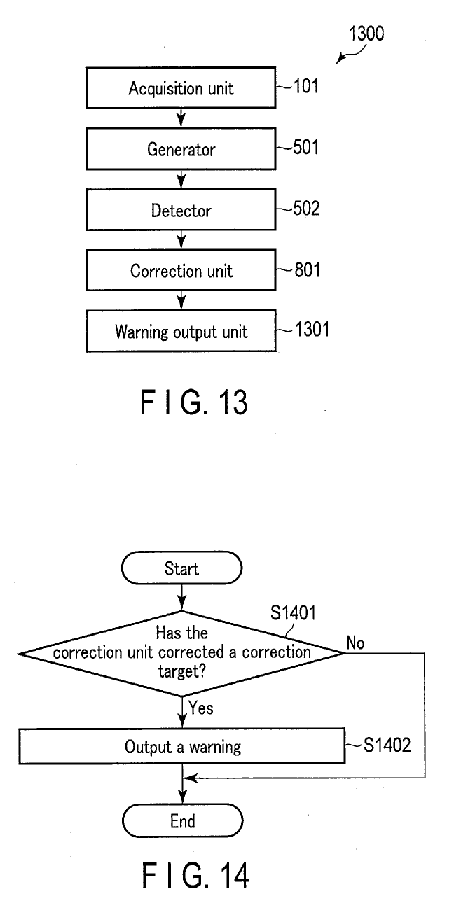

The correction apparatus according to the fourth embodiment is explained with reference to the block diagram of FIG. 13.

A correction apparatus 1300 shown in FIG. 13 includes an acquisition unit 101, a generator 501, a detector 502, a correction unit 801, and a warning output unit 1301.

The acquisition unit 101, the generator 501, the detector 502 and the correction unit 801 perform the same operations as those in the second embodiment, and the explanations thereof will be omitted.

The warning output unit 1301 externally outputs a warning when receiving a notification of correction completion from the correction unit 801.

A warning process of the warning output unit 1301 according to the fourth embodiment will be explained with reference to the flowchart of FIG. 14.

In step S1401, the warning output unit 1301 determines whether the correction unit 801 has made a correction of a correction target. Whether the correction has been made or not may be determined by, for example, receiving a notification relating to correction completion from the correction unit 801. If the correction unit 801 has made the correction, the process proceeds to step S1402, and if not, the process is ended.

In step S1402, the warning output unit 1301 outputs a warning to the effect that the correction has been completed.

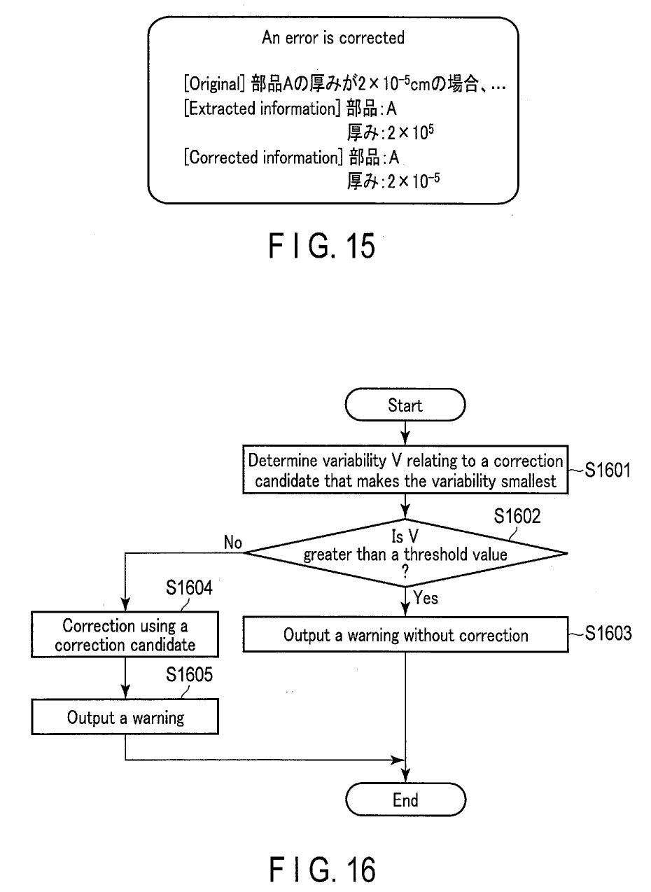

An example of an output of a warning by the warning output unit 1301 according to the fourth embodiment will be explained with reference to FIG. 15.

In the example of the output of the warning shown in FIG. 15, a message “an error is corrected” is displayed along with an original text, extracted information, and corrected information. Looking at the warning shown in FIG. 15, the user can immediately understand what correction has been made.

According to the fourth embodiment described above, because of the output of the warning relating to the information before and after the correction, the user can easily determine whether the result of correction is appropriate or not.

### Fifth Embodiment

The fifth embodiment differs from the embodiments described above in that a warning is given if the detector detects a correction target but the correction target is not corrected.

A correction apparatus of the fifth embodiment is similar to the configuration shown in FIG. 13, but different in the operations of the correction unit 801 and the warning output unit 1301.

An operation of the correction apparatus according to the fifth embodiment will be described with reference to the flow chart of FIG. 16.

In step S1601, a detector 502 determines variability V relating a correction candidate that makes the variability smallest.

In step S1602, the detector 502 determines whether the variability V is greater than a threshold value. If the variability V is greater than the threshold value, the process proceeds to step S1603. If the variability V is equal to or smaller than the threshold value, the process proceeds to step S1604.

In step S1603, the warning output unit 1301 outputs a warning. This is because even if a correction candidate that makes the variability smallest is obtained, if the variability is greater than the threshold, the correction candidate may be erroneous. Therefore, in this case, the correction unit 801 does not make correction and the warning output unit 1301 outputs a warning.

In step S1604, the correction unit 801 corrects the correction target to a correction candidate.

In step S1605, the warning output unit 1301 outputs a warning.

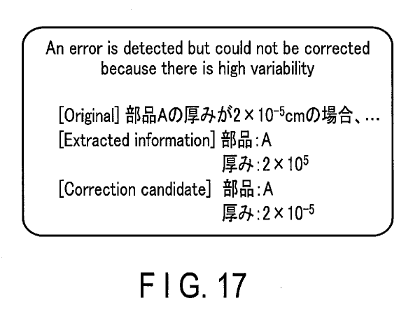

An example of an output of a warning by the warning output unit 1301 according to the fifth embodiment will be explained with reference to FIG. 17.

In the example shown in FIG. 17, a message “an error is detected but could not be corrected because there is high variability” is displayed along with an original text, extracted information (correspondence information), and a correction candidate.

According to the fifth embodiment described above, if a value of the smallest variability is greater than the threshold value, no correction is made. As a result, the risk of erroneous correction can be reduced, and the versatility of correction can be enhanced.

The instructions indicated in the operation procedure of the above-described embodiments can be carried out based on a software program. It is possible to configure a general-purpose calculating system to store this program in advance and to read the program in order to achieve the same advantageous effects as those achieved by the correction apparatus described above. The instructions described in the above embodiments are recorded in a magnetic disc (flexible disc, hard disc, etc.), an optical disc (CD-ROM, CD-R, CD-RW, DVD-ROM, DV+R, DVD+RW, Blu-ray disc, etc.), a semiconductor memory, or similar storage medium, as a program executable by a computer. As long as a storage medium is readable by a computer or an embedded system, any storage type can be adopted. An operation similar to the operation of the correction apparatus of the above-described embodiments can be realized if a computer reads a program from the storage medium, and executes the instructions written in the program on the CPU based on the program. A program can be obtained or read by a computer through a network, of course.

Furthermore, an operating system (OS) working on a computer, database management software, middleware (MW) of a network, etc. may be executed a part of processes for realizing the embodiments based on instructions from a program installed from a storage medium onto a computer and an embedded system.

Furthermore, the storage medium according to the embodiments is not limited to a medium independent from a system or an embedded system; a storage medium storing or temporarily storing a program downloaded through LAN or the Internet, etc. is also included as the storage medium according to the embodiments.

Furthermore, a storage medium is not limited to one; when the process according to the embodiments is carried out using a plurality of storage media, these storage media are included as a storage medium according to the embodiments, and can take any configuration.

The computer or embedded system in the embodiments are used to execute each process disclosed in the embodiments based on a program stored in a storage medium, and the computer or embedded system may be an apparatus including one PC or one microcomputer, etc. or a system in which a plurality of apparatuses are connected through network, etc.

The computer adopted in the embodiments is not limited to a PC; it may be an arithmetic processing unit, a microcomputer, etc. included in an information processor, and a device and apparatus that can realize the functions disclosed in the embodiments by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A correction apparatus comprising:
an acquisition unit that acquires a plurality of entries each including a plurality of elements; and
a detector that extracts, from the plurality of entries, a plurality of second entries each having a second element which is common to a second element of a first entry, the first entry being an entry selected from the plurality of entries, the second element of the first entry being an entry other than a first element of the first entry, the first element of the first entry being an element selected from elements included in the first entry, and detects whether or not the first element of the first entry is a correction target based on first elements of the second entries.

2. The correction apparatus according to claim 1, wherein the detector detects the first element of the first entry as a correction target if variability in a set of the first element of the first entry and the first elements of the second entries is equal to or greater than a first threshold value.

3. The correction apparatus according to claim 1, further comprising a generator that generates a plurality of correction candidates from the first element of the first entry in accordance with a generation rule,
wherein the detector calculates variability in a set of the first elements of the second entries and each of the correction candidates, and detects the first element of the first entry as a correction target if a correction candidate that makes the variability smallest is different from the first element of the first entry.

4. The correction apparatus according to claim 2, further comprising an output unit that outputs a warning if the correction target is detected.

5. The correction apparatus according to claim 3, further comprising a correction unit that corrects the first element of the first entry to the correction candidate.

6. The correction apparatus according to claim 5, further comprising an output unit that outputs a warning if the first element of the first entry has been corrected.

7. The correction apparatus according to claim 6, wherein if the variability relating to the correction candidate is equal to or greater than a second threshold value, the correction unit fails to correct the first element of the first entry to the correction candidate, and the output unit outputs a warning indicating that no correction is made.

8. The correction apparatus according to claim 1, wherein each of the elements is a character string or a numerical value.

9. The correction apparatus according to claim 1, wherein the first element corresponds to a first item, and the second element corresponds to a second item different from the first item.

10. The correction apparatus according to claim 1, wherein the second element includes one or more elements.

11. A correction method comprising:
acquiring a plurality of entries each including a plurality of elements;
extracting, from the plurality of entries, a plurality of second entries each having a second element which is common to a second element of a first entry, the first entry being an entry selected from the plurality of entries, the second element of the first entry being an entry other than a first element of the first entry, the first element of the first entry being an element selected from elements included in the first entry; and
detecting whether or not the first element of the first entry is a correction target based on first elements of the second entries.

12. The correction method according to claim 11, wherein the detecting whether or not the first element of the first entry is the correction target comprises detecting the first element of the first entry as a correction target if variability in a set of the first element of the first entry and the first elements of the second entries is equal to or greater than a first threshold value.

13. The correction method according to claim 11, further comprising generating a plurality of correction candidates from the first element of the first entry in accordance with a generation rule,
wherein the detecting whether or not the first element of the first entry is the correction target comprises calculating variability in a set of the first elements of the second entries and each of the correction candidates, and detecting the first element of the first entry as a correction target if a correction candidate that makes the variability smallest is different from the first element of the first entry.

14. The correction method according to claim 12, further comprising outputting a warning if the correction target is detected.

15. The correction method according to claim 13, further comprising correcting the first element of the first entry to the correction candidate.

16. The correction method according to claim 15, further comprising outputting a warning if the first element of the first entry has been corrected.

17. The correction method according to claim 16, wherein if the variability relating to the correction candidate is equal to or greater than a second threshold value, the first element of the first entry is not corrected to the correction candidate, and the outputting the warning comprises outputting a warning indicating that no correction is made.

18. The correction method according to claim 11, wherein each of the elements is a character string or a numerical value.

19. The correction method according to claim 11, wherein the first element corresponds to a first item, and the second element corresponds to a second item different from the first item.

20. A non-transitory computer readable medium including computer executable instructions, wherein the instructions, when executed by a processor, cause the processor to perform a method comprising:
acquiring a plurality of entries each including a plurality of elements;
extracting, from the plurality of entries, a plurality of second entries each having a second element which is common to a second element of a first entry, the first entry being an entry selected from the plurality of entries, the second element of the first entry being an entry other than a first element of the first entry, the first element of the first entry being an element selected from elements included in the first entry; and
detecting whether or not the first element of the first entry is a correction target based on first elements of the second entries.
